(19) United States
(12) Patent Application Publication
(10) Pub. No.: US 2013/0273345 A1
(43) Pub. Date: Oct. 17, 2013

(54) Non-linear Optical Response Materials

(71) Applicants: Lay-Lay Chua, Singapore (SG); Peter Ho, Singapore (SG); Geok Kieng Lim, Singapore (SG)

(72) Inventors: Lay-Lay Chua, Singapore (SG); Peter Ho, Singapore (SG); Geok Kieng Lim, Singapore (SG)

(73) Assignees: DSO NATIONAL LABORATORIES, Singapore (SG); NATIONAL UNIVERSITY OF SINGAPORE, Singapore (SG)

(21) Appl. No.: 13/977,366

(22) PCT Filed: Dec. 28, 2011
(86) PCT No.: PCT/SG2011/000452

§ 371 Date: Jun. 28, 2013

Related U.S. Application Data
(60) Provisional application No. 61/427,570, filed on Dec. 28, 2010.

(51) Int. Cl. G02F 1/361; G02F 1/35

(52) U.S. Cl. CPC G02F 1/3611; G02F 1/3523
USPC 428/221; 359/337.1; 427/164; 252/582

(57) ABSTRACT

An optical-limiter is disclosed herein. In an embodiment, the optical limiter comprises chemically functionalized graphene substantially spaced apart as single sheets in a substantially transparent liquid cell or solid thin film. A method of fabricating an optical response material is also disclosed.

### FIELD

The present invention relates to a non linear optical response material.

### BACKGROUND

The intensity and shape of laser pulses need to be manipulated in a number of advanced optical technologies. To achieve the required response speed, passive devices employing nonlinear optical materials are essential. Saturable absorbers exhibit increased transmittance at high optical intensities or fluences, which is useful for pulse compression, Q-switching and mode locking. In contrast optical limiters exhibit decreased transmittance through a variety of mechanisms such as excited-state absorption, two-photon absorption, free-carrier absorption, nonlinear refraction and scattering. This can also be used for pulse shaping and mode locking in advanced optical technologies, but most importantly for protection of optical and focal-plane array sensors from irreversible damage by intense pulses and thus extension of their survivability dynamic range.

Various materials exhibit OL characteristics including giant π-electron systems such as carbon-black suspensions (CBS), single- and multi-wall carbon nanotube (CNT) suspensions, and small π-electron systems such as fullerenes, porphyrins and phthalocyanines. For over a decade now, the performance benchmark for broadband OL has been held by CBS and CNT suspensions. Their OL property arises primarily through nonlinear scattering of breakdown-induced microplasmas. However this mechanism is not effective against pulses shorter than a few ns due to the induction time, or in solid films because it destroys (vaporizes) the material. The small π-electron systems on the other hand can show OL due to excited-state absorption (also called “reverse saturable absorption”) through build-up of the triplet population at the sub-ns time scale. The ratio of excited-to-ground-state absorption coefficients however strongly depends on the pump wavelength and hence these materials cannot provide broadband coverage.

Both graphene and graphene oxide suspensions have recently been reported to show broadband OL in a variety of solvents with nonlinearity thresholds and clamping (i.e. output-limiting) characteristics that are broadly similar to those of CBS and CNT suspensions The measured off-axis scattering suggests indeed a similar nonlinear scattering mechanism. Therefore CBS and CNT suspensions provide the best performance prior to this invention for broadband optical limiting. Despite their many limitations (chiefly, their ineffectiveness in solid thin films), no other materials can match comparable performance.

Furthermore, state-of-the-art work on graphene and graphene oxide suspensions show that they too do not greatly differ from CBS and CNT suspensions in their optical limiting characteristics or mechanism.

For example, WO2010129196 involves dispersing of heavily-oxidized graphene oxide sheets (GOx) in water and unfunctionalized graphene sheets (GS) in water or organic solvents with addition of stabilizing reagents. Evidently, these dispersions are still not very stable and precipitate over time and thus their optical limiting mechanism arises primarily through nonlinear scattering of breakdown-induced microplasmas. Moreover, their optical limiting effect is inferior.

### SUMMARY

In general terms the invention relates to surface chemically-functionalized graphenes, such as functionalized sub-stoichiometric graphene oxides (sub-GOx), when dispersed as single sheets in appropriate liquid cells (such as solvents containing heavy-atoms) or film matrices. This may provide extremely efficient nanosecond optical-limiting characteristics for pulse shaping and anti-glare application. These dispersions may display an ability to limit the optical power of intense light sources with non-linearity onset thresholds, half-transmittance thresholds and clamping levels that are vastly superior to previously known materials by 5-10 times, and are effective over a broadband of wavelengths from ultraviolet to near infrared, and for pulses from sub-nanosecond to tens of microseconds.

In a first expression of the invention there is provided a method of fabricating an optical response material comprising:
providing single sheet graphene;
functionalizing the graphene to substantially prevent agglomeration; and
forming a solid thin film including the graphene, wherein the graphene is substantially dispersed within the film.

Preferably, the single sheet graphene is functionalized sub-stoichiometric oxidized graphene.

Forming the film may comprise dissolving the graphene in solution and depositing the solution on a substrate. Further, forming the film may comprise dispersing the graphene in a solid film.

Preferably, the onset of the nonlinear optical limiting effect in the thin film or liquid cell is less than 100 mJ/cm² or more preferably less than 10 mJ/cm² when the liner transmittance preferably fall between 50-90%.

In a second aspect of the invention there is provided an optical-limiter comprising:
a liquid cell or a film matrices, and
single sheet chemically functionalized graphene substantially dispersed within the liquid cell or solid thin film.

Preferably, the chemical functionalization comprises both sub-stoichiometric oxidation, and attachment of surface modifier groups, wherein the surface-modifier group may comprise solubilizing groups from the class including alkyl, cycloalkyl, aryl, arylalkyl, fluoroalkyl and fluoroaryl groups; and/or ionic groups from the class including carboxylic acid, sulfonic acid, phosphonic acid and their salts, quarternary ammonium; and/or polar groups from the class including ester, amide, nitro, cyano; sulfone, sulfoxide; and/or heavy atoms from the class including sulfur, chlorine, bromine, iodine, cadmium, mercury, silver, gold platinum, palladium, yttrium, zirconium, lanthanum, cerium, caesium, barium; and/or electron withdrawing groups; and/or electron donating groups.

The liquid cell may be from the class of heavy atoms solvents with its atomic number bigger than 20. Preferably, the liquid cell is from the class of haloaromatics including chlorobenzene, dichlorobenzenes, trichlorobenzenes, bromobenzene, dibromobenzenes and tribrombenzenes, and their higher halogenated or mixed halogenated analogues. More preferably, the liquid cell is from the class of electron-withdrawing and/or electron-donating solvents.

The solid thin film may be from the class of transparent matrices, including polymers such as polycarbonates, polyimides, polyesters, polyacrylates, polycarbazoles, epoxy polymers, novalak, formaldehyde polymers, polymer containing heavy-atoms, polymer containing electron withdrawing groups, polymer containing electron donating group and sol-gel materials, including sol-gel silica, sol-gel titania, silsequioxanes.

The optical-limiting mechanism may occur by excited state absorption.

In a third aspect, there is provided a thin film comprising an optical limiting layer according to any of the above features.

In a fourth aspect, there is provided a device selected from the group consisting of an anti-glare treated device and a sensor protected with pulse shaping, comprising an optical limiter according to any of the above features.

Embodiments may have the benefits of:
(i) high-performance OL liquid cells can be achieved (5-10 times better in performances than previously known as indicated by onset fluence for nonlinearity, half-transmittance fluence and the clamping levels.
(ii) high-performance and robust state-state optical limiting films can also be achieved for the first time to broadband (from UV to NIR) nanosecond pulses to tens of microsecond without observable damage
(iii) high dispersability in a variety of solvents and solid matrices without significant aggregation or agglomeration
(iv) high concentrations are possible
(v) linear transmittance in the 50-90% range
(vi) effective over a broadband of wavelengths from ultraviolet to near infrared
(vii) an excited-state absorption mechanism from long-lived spin-unpaired excited states

### BRIEF DESCRIPTION OF DRAWINGS

One or more example embodiments of the invention will now be described, with reference to the following figures, in which:

FIG. 1 is a graph of output fluence Fₒᵤₜ vs input fluence Fᵢₙ characteristic of FIG. 1(a) functionalized sub-GOx in bisphenol-A polycarbonate (PC) film at 1064-nm (with a schematic of Z-scan technique shown as an inset); FIG. 1(b) functionalized sub-GOx and GOx in PC films at 532-nm wavelength. Pure PC film does not give any optical limiting.

FIG. 2 is a graph of output fluence Fₒᵤₜ vs input fluence Fᵢₙ characteristics of the functionalized sub-GOx in bisphenol-A polycarbonate (PC) and poly(methyl methacrylate) (PMMA) films at 532-nm wavelength. Pure film of functionalized sub-GOx with extensive inter-sheet contacts does not give any optical limiting.

FIG. 3 is a graph for a liquid cell: Functionalized sub-GOx shows saturable absorption in N-methylpyrrolidone (NMP), tetrahydrofuran (THF), anisole (ANS) and mesitylene (MES) dispersions (T′=0.9) over the Fᵢₙ plotted here, but optical-limiting property in chlorobenzene (CB), 1,2-dichlorobenzene (DCB) and 1,2,4-trichlorobenzene (TCB) (T′=0.10) that is stronger than single-wall CNT in THF and C₆₀ in toluene (TOL). All in 1.0-mm path length cells. T′ is the limiting differential transmittance

FIG. 4 is a graph of output fluence Fₒᵤₜ vs input fluence Fᵢₙ characteristics of functionalized sub-GOx, GOx dispersions and ultrasonically-exfoliated unfunctionalized graphene dispersions in heavy-atom liquid cells.

FIG. 5 comprising FIGS. 5a and 5b are graphs of differential scanning calorimetry of the graphene nanocomposites. FIG. 5a is a graph of glass transition temperature (T_{g}) of PS increases significantly by 7° C. from 91° C. to 98° C., while that of PMMA in FIG. 5b by 9° C. from 98° C. to 107° C. in the presence of only 4 wt % of functionalized sub-GOx. This confirms that the sub-GOx are homogeneously and well-dispersed among the polymer chains

FIG. 6 is a graph of wavelength dependent output fluence Fₒᵤₜ vs input fluence Fᵢₙ characteristics of functionalized sub-GOx dispersed in CB measured using a 7-ns tunable laser from 450-nm to 750-nm by Z-scan technique with f/30 optics and 1.0-mm path length cells.

FIG. 7 is a Z scan of a graphene nanocomposite film according to an embodiment, showing no damage after repeated laser pulses.

FIG. 8 are graphs illustrating normalized transient transmittance ΔT/T spectra as a function of pump-probe delay for sub-GOx dispersed in CB at 532-nm wavelength, with different values of Pump fluence: (a) 2, (b) 20, (c) 30 and (d) 90 mJ cm⁻². This pump fluence is weighted by the probe intensity profile. The temporal resolution is 0.7 ns due to pump width and jitter. Repetition rate is 500 Hz. The 525-550-nm region is masked off by notch filter. For (b) and (c) the 610-750-nm region has been smoothed to reduce clutter.

FIG. 9 comprising FIGS. 9a and 9b are schematic diagrams outlining new optical-induced absorption mechanisms with 9(a) showing Localisation of the excited states in dispersed graphene single sheets give (i) excitons (neutral excited state) or (ii) polarons (charged excited state); and FIG. 9(b) For comparison, graphite shows photo-induced transparency that is very short-lived due to fast cooling and recombination.

FIG. 10 are graphs showing p-Doping of functionalized sub-GOx with F₄TCNQ, with (a) Solution-state UV-Vis-NIR spectra of functionalized sub-GOx (0.10 mg mL⁻¹, equivalent to 1.0×10¹⁸ basal C₂ unit cells/cm²) dispersed in CB and p-doped with increasing ratio of F₄TCNQ, measured in a 2.0-mm pathlength cell at 298 K. The mole ratio of added F₄TCNQ has been normalized to the C₂ unit cells. The spectra have been corrected for the volume dilution effect, and so referred to constant functionalized sub-GOx concentration. (b) Difference UV-Vis-NIR spectra obtained by subtraction of the pristine spectrum. (c) Plot of the F₄TCNQ anion per unit cell (left) and the doping-induced broadband absorbance (right) against the added total F₄TCNQ per unit cell. (d) Plot of the absorbance of the doping-induced broadband against doping level of the functionalized sub-GOx.

FIG. 11 is a graph showing Liquid-cell Raman spectra of octadecylamine-functionalized sub-GOx dispersed in four different solvents. Functionalized sub-GOx in mesitylene (MES), in anisole (ANS), in chlorobenzene (CB) and in 1,2-dichlorobenzene (DCB) at a concentration of ca. 0.1 mg mL⁻¹. Solvent peaks have been removed by subtraction. Laser excitation wavelength, 532 nm.

FIG. 12 shows a schematic structure of a functionalized sub-GOx sheet. The sheet comprises nano-graphene domains separated by alkyl-functionalized and oxygenated spa-carbon network.

FIG. 13 (a) is a Raman spectra of GOx. Heavily-oxidized GOx and sub-GOx films before and after chemical functionalization with octadecylamine solubilizing chains. Excitation wavelength is 514 nm FIG. 13 (b) shows UV-Vis-NIR spectrum of functionalized sub-GOx dispersed in KBr pellet. 0.3 mg functionalized sub-GOx in 200 mg KBr. Scattering losses in the KBr pellet is small (<0.1 absorbance units).

FIG. 13 (c) is a calibration plot of the energy gap of the benzenoid PAHs vs their diameter. Data taken from Ref.[2]. Energy gap is given in eV, and diameter is given by the square root of the number of aromatic sextets in the PAHs. Each aromatic sextet has a physical diameter of 0.426 nm.

### DETAILED DESCRIPTION

According to one embodiment when graphenes, and sub-stoichiometric graphene oxides (sub-GOx) which are representative members of the class of functionalized graphenes, are dispersed as single sheets in heavy-atom solvents, electron-withdrawing solvents, electron-donating solvents or in film matrices, these functionalized (and unfunctionalized) graphenes may exhibit a giant OL response with nonlinearity thresholds that may be ten times lower than (and hence superior to) the previous benchmarks set by CBS and CNTs, and may also exhibit desirable broadband absorption and optical limiting. The functionalized graphenes may exhibit dispersability in a variety of solvents and solid matrices.

Functionalized graphenes may be dispersed substantially as single sheets rather than aggregated multilayer stacks as previously used.

Various surface chemically-functionalized sub-GOx and ultrasonically-exfoliated unfunctionalized graphene nanosheets may show this giant OL enhancement. Graphene nanosheets means graphene and graphene oxide sheets having a basal plane fraction of carbon atoms in the sp²-hybridized state between 0.1 and 0.9, wherein the remainder fraction of carbons atoms comprises sp³-hybridized carbon atoms which are bonded to oxygen groups selected from hydroxyl and/or epoxy and/or carboxylic acid. Therefore the effect is a feature of the extended pi-electron system that is present in the entire class of graphenes, whether functionalized or not. Appropriate surface chemical functionalization may improve dispersion at higher concentrations (between 1 mg/mL and 15 mg/mL; unfunctionalized graphene sheets not be sufficiently dispersed in concentrations above 0.1 mg/mL). Chemical functionalization may achieve “single-sheet” dispersion (SLG), meaning a state in which that the graphene sheets remain permanently dispersed in the solvent without aggregating (i.e., re-stacking) to give bilayer graphene (BLG) few-layer graphene (FLG) or multi-sheet objects.

Aggregation may lead to the settling out of the graphene materials and may suppress the giant OL effect, even for incipient aggregation that has not yet caused precipitation. Functionalization may thus prevent close sheet-to-sheet contact which may be detrimental to the giant OL property. The previous use of aggregated graphenes and sub-GOx in other studies in which FLG or multilayer sheets objects are formed in the suspension may be the main reason why the giant OL effect has not been found before. As long as it is not a single sheet dispersion, aggregation or agglomeration is said to have happened. Aggregation and agglomeration can result in FLG or multi-sheets objects. Typically, in this field, FLG is known to be more than two layer and less than 10 layers of stacked graphene sheets and multi-sheets objects are more than 10 layers of stacked graphene. This functionalization may promote an interaction with the solvent, and may suppress the tendency for sheet-to-sheet stacking. This may be encouraged with an atom group of the nanosheets of diameter bigger than 2 Angstroms. Unfunctionalized sub-GOx may be prone to restacking which may destroy the desired OL properties. Furthermore, it may be important to ensure that the graphene does not become fully oxidized, but remains in the sub-stoichiometric oxidized state, because the OL effect is a property of the extended pi-conjugation present in the sheets. “Functionalized graphenes”, may be derived from the functionalization of sub-stoichiometric graphene oxides, or other compounds, such as graphite intercalation compounds, fluorinated graphite, hydrogenated graphite, or other partially reacted graphite compounds. Thus SLG that has a basal plane fraction of carbon atoms in the sp²-hybridized state between 0.1 and 0.9, wherein the remainder fraction of carbons atoms comprises, consists of sp³-hybridized carbon atoms which are bonded to oxygen groups selected from hydroxyl and/or epoxy and/or carboxylic acid and may be obtained either from functionalized sub-oxidized graphene oxide or directly by functionalizing graphite to give single graphene sheets.

### Obtaining Fully-Dispersable Single-Sheet Graphenes

Examples of appropriate chemical functionalizations include surface-grafting with alkyl, cycloalkyl, aryl, arylalkyl, fluorocarbon, alkyleneoxy surface-chains. These chains are chosen principally to provide the desired dispersability in the chosen liquid cell or solid film. To achieve the required molecular compatibilization with the liquid cell or solid matrix, the chains could further optionally be functionalized with functional groups such as ionic groups from the class of carboxylic acid, phosphonic acid, sulfonic acid, or quarternized ammonium, or polar groups such as carbonyl, ester, amide, nitro, or hydroxyl group.

### Promoting Spin-Unpaired Excited States

Another design principle for the surface-functionalization may be the use of groups to promote the formation of long-lived excited states. A mechanism for this giant OL effect may arises from a new excited-state absorption mechanism from long-lived spin-unpaired excited states. This mechanism is different from the nonlinear scattering mechanism due to breakdown that operates in CBS and CNT suspensions, and the triplet absorption mechanism in fullerenes and other molecules with small pi-electron systems. It may be a unique feature of the dispersed (i.e., molecularly separated) state of graphene including sub-GOx nanosheets, in which its band electronic structure becomes localized by interaction with the medium at high excitation densities to give long-lived and apparently spin-unpaired states.

In liquid cells, a large “heavy-atom” effect from solvents containing chlorine and bromine may exist. The heavy-atom effect refers to the enhancement of a spin-forbidden presence in the presence of a heavy atom that is a part of or external to the molecule. Heavy atoms are atoms with atomic number bigger than about 20, e.g. the following in an appropriate covalent or ionic form: sulphur, chlorine, bromine, iodine, selenium, cadmium, mercury, silver, gold platinum, palladium, yttrium, zirconium, lanthanum, cerium, caesium, barium. They exhibit large spin-orbit coupling of the electrons that allow the singlet state of neighbouring systems to intersystem cross to a lower-energy triplet state faster than the natural rate. This is a characteristic signature of the participation of triplet states. It may be advantageous to also incorporate such heavy atoms into the surface functionalization of the graphene sheets

For example it was reported previously that graphenes have weak optical-limiting effect in solvents like tetrahydrofuran, N,N-dimethylformamide, N,N-dimethylacetamide, N-methylpyrolidone, γ-butyrolactone, using a nonlinear scattering mechanism. However according to an embodiment, graphenes may exhibit a giant OL effect in solvents such as chlorobenzene, 1,2-dichlorobenzene, 1,2,4-trichlorobenzene, bromobenzene.

### Promoting Exciton Localization

Yet another design principle for the surface-functionalization may be the use of strong electron-withdrawing and/or electron-donating groups. Such groups stabilize and localise the excited state and thereby provide for large absorption cross-sections.

In some cases, this giant OL effect can be further enhanced by strong electron-withdrawing and/or electron-donating effect of solvents.

### Single-Sheet Dispersion in Liquid Cells

The dispersability at the single-sheet level in a variety of solvents is readily confirmed by any of the following: (i) resilience to centrifuge sedimentation at up to 1000 g (g=earth's gravity) for 10 min, (ii) appearance of extensively single-sheet films with the correct step heights upon spin-casting, and (iii) dynamic light scattering indicates the absence of aggregation. Typically these cells are fabricated by dispersing the functionalized graphenes to a concentration of 30-100 microgram/mL in 1.0-mm-pathlength cells, with light sonication as necessary, to give a linear transmittance of 0.7 at the desired blocking wavelength. The exact concentration required depends on the extent of functionalization of the graphene which affects its absorptivity, and can be determined readily by experiments from a standard Beer's law plot, and the path length selected. The concentration required is inversely proportional to this path length. So for example, if the path length is decreased from 1.0 mm to 100 micrometers, for example, through the use of spacers, the required concentration is increased correspondingly by a factor of ten. The functionalized graphenes typically have dispersability well above 1 mg/mL, so it is not difficult to achieve the correct concentration. The exact linear transmittance required will depend on application and the rest of the optical design, but will usually fall between 0.5 and 0.9.

### Single-Sheet Dispersion in Solid Films

It is also determined that these functionalized graphenes can be dispersed substantially as single sheets in solid thin films with other materials as compatible matrices. Compatibilization between the functionalized graphenes and the matrix is provided by the presence of the surface modifier group. The use of alkyl side chains (hexyl to octadecyl) in the surface-modifier group provides compatibilization with a variety of polymers including poly(methyl methacrylate), polystyrene, poly(dimethylsiloxane), poly(carbonate) and semiconducting conjugated polymers, chiefly by decreasing the tendency of the graphene sheets to re-stack and improving the van der Waals interaction with the polymers. Other solubilising groups that can be incorporated into the surface-modifier group includes cycloalkyl (e.g., adamantyl, cyclohexyl, cyclopentyl), aryl (e.g, phenyl), arylalkyl (e.g., phenylethyl), fluoroalkyl (e.g., perfluorohexyl, perfluorodecyl), fluoroaryl (e.g., pentafluorophenyl). Their selection depends on the nature of the matrix. In general, fluoroalkyl chains will promote compatibility with fluoropolymers, such as poly(perfluoroalkyl methacrylate), and poly[(tetrafluoroethylene)-co-(2,2-bis-trifluoromethyl-4,5-difluoro-1,3-dioxole)]. Furthermore the use of polar groups from the class including ester, amide, nitro, cyano, sulfone, and sulfoxide, in the surface-modifier group will improve the dispersability of the functionalized graphenes into polar engineering polymers or their precursors, including polyimides such as poly(oxydiphenylenepyromellitimide), polyetherimide, and polysulfones such as poly(bisphenol-A-dimethylsulfone).

The use of ionic groups from the class including carboxylic acid, sulfonic acid, phosphonic acid and their salts, and quarternary ammonium groups will improve the dispersability of the functionalized graphenes into water- and other polar-solvent-soluble polymers such as poly(vinyl alcohol), poly(hydroxystyrene), including polyelectrolytes such as poly(styrenesulfonic acid), poly(acrylic acid) and their salts, and sol-gel materials such as silica from tetraethyl orthosilicate or silsesquioxane, titania from titanium tetrachloride, and zirconia from zirconium tetrachloride.

The design principle for the matrix is similar to that for the solvents. Although giant OL effect is already possible in matrices of simple polymers such as poly(methyl methacrylate) and poly(bisphenol-A carbonate), it may be further enhanced by heavy atom effect and/or strong electron-withdrawing and/or electron-donating effects through the appropriate choice of polymers.

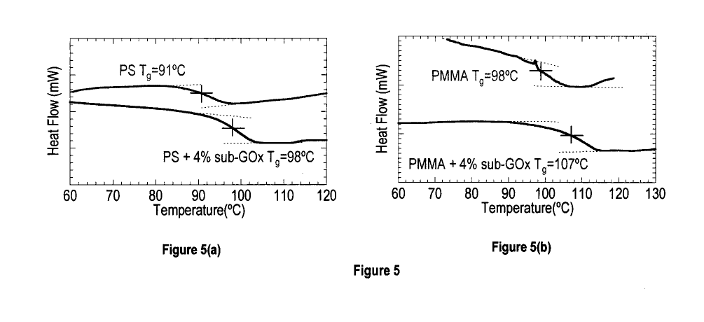

The adequacy of the dispersion is evidenced in some case, e.g., of amorphous polymer matrices, such polystyrene and poly(methyl methacrylate), by the shift of their glass transition temperatures (T_{g}) which is a well-established signature for fine dispersions at the molecular scale in polymers. If the sheets were aggregated, they will have no effect on the T_{g} of the polymer at the concentrations at which they were used (2-5 w/w %). The authors in fact found measurable changes of a few degrees Celsius as shown in FIG. 5. The glass transition temperature measures the molecular interaction between adjacent polymer chains. If the T₉ is shifted, it means the intermolecular interaction between the polymer chains is influenced by a nearby graphene sheet, which means that these sheets must be in the vicinity of all the chains, which implies they are well dispersed at the single-sheet level, rather than as aggregated stacks. In solid matrices, however, it is not necessary (although it could be advantageous) to activate the heavy-atom effect to achieve the giant OL effect.

### Commercial Production Methods

These composites can be made by dispersing the functionalized graphenes in a solvent in which the matrix material or its precursor is dispersed, and then forming the film by spin-coating, doctor blading or printing. Optionally, standard lithography can also be applied to pattern the film if desired. Then the composite film is dried or cured. Alternatively the functionalized graphene can also be dispersed into the matrix by compounding at elevated temperatures or by ball-milling, followed by film formation.

For example techniques such as those described in WO2009085015, which is incorporated herein by reference, can be used to alkyl-functionalize sub-oxidized graphene oxide sheets. Not all methods of fabricating SLG are applicable especially if the result also contains FLG, BLG or multi-layers objects such that they are unstable and agglomeration occurs over time.

Typically the SLG would be batch produced. It can then be deposited using any solution-processing techniques.

### Giant OL Effect

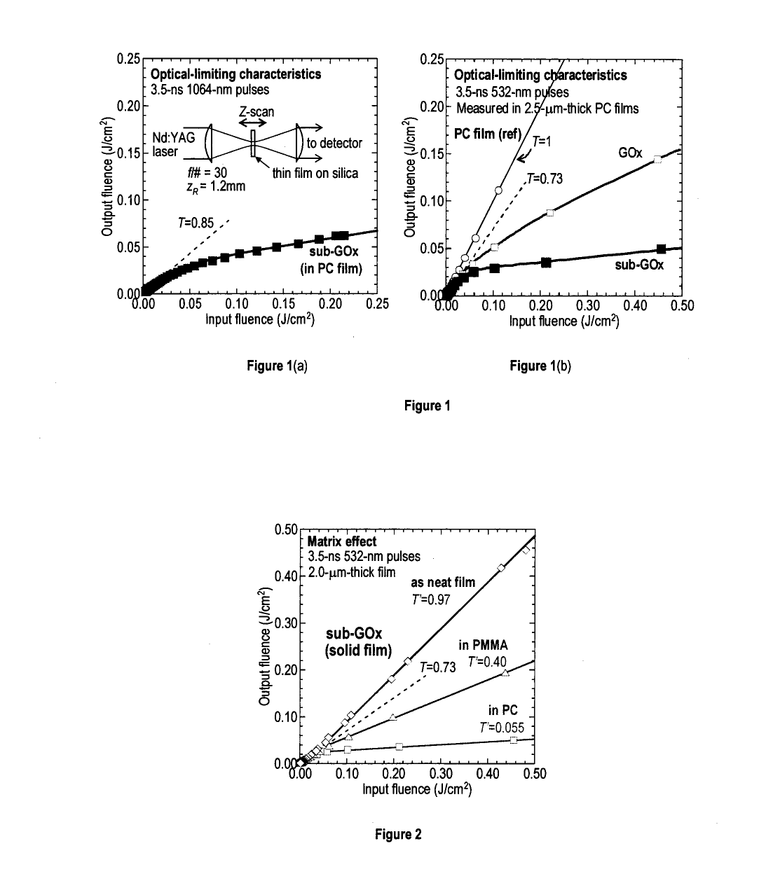

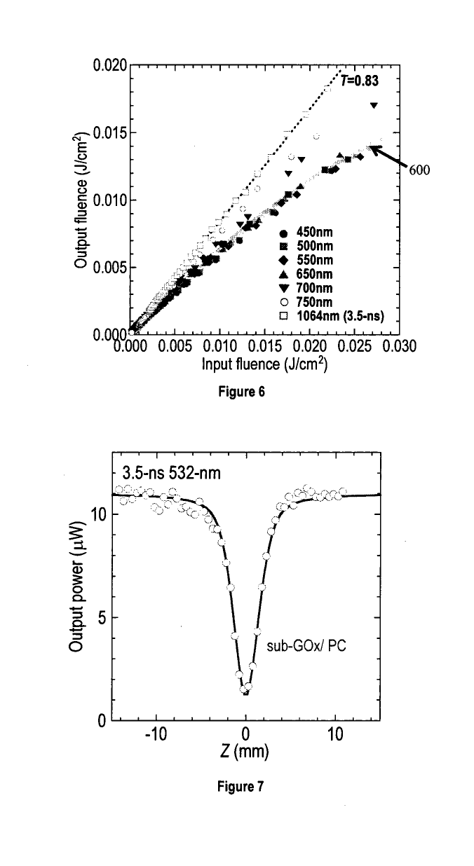

The liquid-cell and solid-film dispersions prepared this way with linear transmittance in the 50-90% range may show a giant optical limiting effect 5-10 times larger than what is previously known. For a typical liquid cell or solid-film transmittance of 70% at 532-nm wavelength, the typical fluence for the onset of optical limiting behaviour (Fₒₙ) is 10 mJ/cm² from 500 nm to 1100 nm wavelength, while the typical half-transmittance threshold (F₅₀) where the transmittance falls to half of the initial (linear) value at low fluences, is 80-100 mJ/cm², for 3.5 ns pulses. The output clamping response, as given by gradient of the Fₒᵤₜ vs Fᵢₙ curve (T′) can be as low as 0.05 at few hundred mJ/cm² for an initial transmittance of 0.7 as shown in FIGS. 1, 2 and 3. Under these conditions, the Fₒₙ and F₅₀ values for CBS, CNT suspensions and for fullerene in toluene at 532-nm-wavelength are 80-100 mJ/cm² and 600-1000 mJ/cm² respectively. Therefore these materials are able to limit the optical output at a much lower incident fluences than what was previously possible. Although most measurements were conducted at the fundamental (1064 nm) and first harmonic (532 nm) wavelength of the Nd:YAG laser, experiments with tunable lasers confirm that the OL effect is truly broadband across the visible to at least the first part of the near-infrared region (500-1100 nm) as shown in FIG. 6. In FIG. 6, data for 1064-nm comes from Nd:YAG laser pulses (3.5 ns) also by Z-scan. The grey line 600 is a guide to the eye for the 450-650-nm data.

In addition, repeated Z-scan measurements on the same spot, shown in FIG. 7, show that the advantageously low threshold observed for the optical-limiting effect is achieved without damage to the films. In this experiment, the sample film can be translated repeatedly through the focus (Z-axis) of a convergent laser beam and struck with >100 shots at focus without changing its OL properties. In contrast, films of CBS, CNTs and even multilayer graphenes are quickly damaged by even a single laser shot to give pinholes (complete transparency) due to destruction of the film. This is because the OL mechanism of those materials derives primarily from nonlinear scattering by microplasmas formed by breakdown of the material. This breakdown of the material is irreversible, and results in volatilisation of the material to give pinholes. Hence the protection ability of the film is lost where the laser shot has struck the film.

### Exemplification 1a

### Preparation of Functionalised Graphene

### Sub-GOx:

Typically, this partially oxidized graphene oxide can be prepared by oxidation of synthetic graphite (for example graphite powder product code 496596 from Sigma Aldrich) using a modified Staudemaier oxidation in concentrated sulfuric-nitric acid with potassium chlorate at room temperature for 7 d, and recovered by filtration and exhaustive washing with Millipore H₂O.

### ODA-Functionalized Sub-GOx:

Typically, this is prepared by mixing of 10 mg of sub-GOx, 100 mg of octadecylamine (ODA) and 60 μL 1,3-diisopropylcarbodiimide in 5 mL of 1,2-dichlorobenzene and heated with intermittent sonication to 80° C. for 24 h under N₂ to give a homogeneous black dispersion. 0.25 mL of this dispersion was mixed with 5 mL of tetrahydrofuran and sonicated briefly, centrifuged at 8000 revolutions per min (8000 rpm, corresponding to 5580 g) for 1 h to extract unpurified functionalized sub-GOx in the supernatant. The purified functionalized sub-GOx was obtained by repeated precipitated with 5 mL of ethanol and centrifuged at 1000 g 1 h.

### Exemplification 1b

### Preparation of Functionalised Graphene

### GOx:

Typically, this more heavily oxidized graphene oxide can be prepared by oxidation of synthetic graphite (for example graphite powder product code 496596 from Sigma Aldrich) using a modified Staudemaier oxidation in concentrated sulfuric-nitric acid with potassium dichromate at room temperature for 7 d, and recovered by filtration and exhaustive washing with Millipore H₂O.

### ODA-Functionalized GOx:

Typically, this is prepared by mixing of 10 mg of sub-GOx, 100 mg of octadecylamine (ODA) and 60 μL 1,3-diisopropylcarbodiimide in 5 mL of 1,2-dichlorobenzene and heated with intermittent sonication to 80° C. for 24 h under N₂ to give a homogeneous black dispersion. 0.25 mL of this dispersion was mixed with 5 mL of tetrahydrofuran and sonicated briefly, centrifuged at 8000 revolutions per min (8000 rpm, corresponding to 5580 g) for 1 h to extract unpurified functionalized GOx in the supernatant. The purified functionalized GOx was obtained by repeated precipitated with 5 mL of ethanol and centrifuged at 1000 g 1 h.

### Exemplification 2

### Preparation of Liquid Dispersion of Unfunctionalized Graphene

In a typical preparation, synthetic graphite (for example graphite powder product code 496596 from Sigma Aldrich) was dispersed in 1,2,4-trichlorobenzene by sonicating 1 mg in 1 mL of solvent for 2 h, and then centrifuged at 1000 g to give a supernatant containing ca. 80 μg mL⁻¹ of dispersed graphene sheets. It can also be dispersed in chlorobenzene and 1,2-dichlorobenzene. Other sources of natural or synthetic graphites can also be dispersed in these solvents.

### Exemplification 3a

### Preparation of Liquid Dispersion of Functionalized Graphene

ODA-functionalized sub-GOx was dispersed in chlorobenzene, 1,2-dichlorobenzene, 1,2,4-trichlorobenzene and bromobenzene separately by brief sonication to form 0.15 mg/mL dispersion. Higher concentration of 0.9 mg/mL dispersion can also be prepared in the same way.

### Exemplification 3b

### Preparation of Liquid Dispersion of Functionalized Graphene

ODA-functionalized GOx was dispersed in chlorobenzene, 1,2-dichlorobenzene, 1,2,4-trichlorobenzene and bromobenzene separately by brief sonication to form 0.15 mg/mL dispersion. Higher concentration of 0.9 mg/mL dispersion can also be prepared in the same way.

### Exemplification 4a

### Preparation of Film of Functionalized Graphene in Bisphenol-A Polycarbonate (PC)

In a typical preparation, a polymer solution of 400 mg mL⁻¹ PC in 10:1 v/v chlorobenzene:1,2,4-trichlorobenzene was prepared at 120° C. in the nitrogen glovebox. 6.0 mg of ODA-functionalized sub-GOx was separately prepared in 0.50 mL CB. 0.50 mL of the PC solution was added to this solution and sonicated 30 min to aid complete dispersion to give 2.9 w/w % ODA-functionalized sub-GOx to total solids. A 2.0-μm-thick film was formed by spin-coating at 3000 rpm on 13-mm-dia. fused silica discs (spectrosil), then baked at 90° C. (hotplate, 5 min).

### Exemplification 4b

### Preparation of Film of Functionalized Graphene in Bisphenol-A Polycarbonate (PC)

In a typical preparation, 9.3 mg of ODA-functionalized GOx was separately prepared in 0.50 mL CB. 0.50 mL of PC solution was added to this solution and sonicated 30 min to aid complete dispersion to give 4.5 w/w % ODA-functionalized GOx to total solids. A 2.0-μm-thick film was formed by spin-coating at 3000 rpm on 13-mm-dia. fused silica discs (spectrosil), then baked at 90° C. (hotplate, 5 min).

### Exemplification 5

### Preparation of Film of Functionalized Graphene in Poly(Methyl Methacrylate)

In a typical preparation, a polymer solution of 400 mg mL⁻¹ of poly(methyl methacrylate) (PMMA) in CB was prepared at 65° C. in the nitrogen glovebox. 12 mg of ODA-functionalized sub-GOx was added to 1.0 mL of this solution and sonicated 30 min to aid complete dispersion to give 2.9 w/w % ODA-functionalized sub-GOx to total solids. A 3.0-μm-thick film was formed by spin-coating at 1000 rpm onto 13-mm-dia. fused silica discs (spectrosil), then baked at 90° C. (hotplate, 5 min).

### Exemplification 6

### Preparation of Film of Functionalized Graphene in Semiconducting Polymer poly(9,9-octylfluorene-alt-triarylamine) (TFB)

In a typical preparation, a polymer solution of 400 mg mL⁻¹ of poly(9,9-octylfluorene-alt-triarylamine) (TFB) in CB was prepared at 65° C. in the nitrogen glovebox. 12 mg of ODA-functionalized sub-GOx was added to 1.0 mL of this solution and sonicated 30 min to aid complete dispersion to give 2.9 w/w % ODA-functionalized sub-GOx to total solids. A 3.0-μm-thick film was formed by spin-coating at 1000 rpm onto 13-mm-dia. fused silica discs (spectrosil), then baked at 90° C. (hotplate, 5 min).

### Exemplification 7

### Preparation of Film of Functionalized Graphene in Polystyrene

In a typical preparation, a polymer solution of 400 mg mL⁻¹ of polystyrene in CB was prepared at 65° C. in the nitrogen glovebox. 12 mg of ODA-functionalized sub-GOx was added to 1.0 mL of this solution and sonicated 30 min to aid complete dispersion to give 2.9 w/w % ODA-functionalized sub-GOx to total solids. A 3.0-μm-thick film was formed by spin-coating at 1000 rpm onto 13-mm-dia. fused silica discs (spectrosil), then baked at 90° C. (hotplate, 5 min).

### Exemplification 8

### Optical Limiting Effect of Functionalized Graphene in Bisphenol-A Polycarbonate (PC)

FIG. 1a shows typical result of the output Fₒᵤₜ vs input Fᵢₙ fluence characteristic of the ODA-functionalized sub-GOx in PC measured for 3.5-ns pulses at 1064-nm wavelength in air. The Fₒᵤₜ/Fᵢₙ ratio gives the internal sample transmittance T. At high fluence, the limiting slope dFₒᵤₜ/dFᵢₙ gives the limiting differential transmittance T′. Thus for a linear T=0.85, the nonlinearity onset Fₒₙ≈10 mJ cm⁻². The half-transmittance threshold F₅₀ where the normalized T falls to 50% of the initial value is 100 mJ cm⁻² with T′=0.17. Therefore this film is OL to 1064-nm-wavelength nanosecond pulses. FIG. 1b shows the corresponding non-linear optical (NLO) characteristic at 532 nm. It also shows for reference that PC does not give any NLO behaviour over this fluence range, while the ODA-functionalized GOx (more heavily oxidized) gives a weaker OL response (F₅₀=300 mJ cm⁻¹ and T′=0.25) at the same linear T. This shows that the OL effect requires an optimal π-electron density.

### Exemplification 9

### Optical Limiting Effect of Sub-GOx in Different Polymer Matrices

FIG. 2 shows typical result of the output Fₒᵤₜ vs input Fᵢₙ fluence characteristic of the ODA-functionalized sub-GOx in different matrix measured for 3.5-ns pulses at 532-nm wavelength in air. The Fₒᵤₜ/Fᵢₙ ratio gives the internal sample transmittance T and the limiting slope dFₒᵤₜ/dFᵢₙ gives the limiting differential transmittance T′ at higher fluence. The film pure of ODA-functionalized sub-GOx with extensive inter-sheet contacts does not give any OL in the measured fluence range, but nearly perfect saturable absorption with T′=0.97 above Fₒₙ≈10 mJ cm⁻². When dispersed in PMMA, the same sub-GOx shows a much weaker OL response (T′=0.40). Therefore, the optical limiting behavior depends crucially on the dispersion of these sub-GOx nanosheets and exhibits a marked matrix effect.

### Exemplification 10

### Optical Limiting Effect of Sub-GOx in Liquid Dispersions

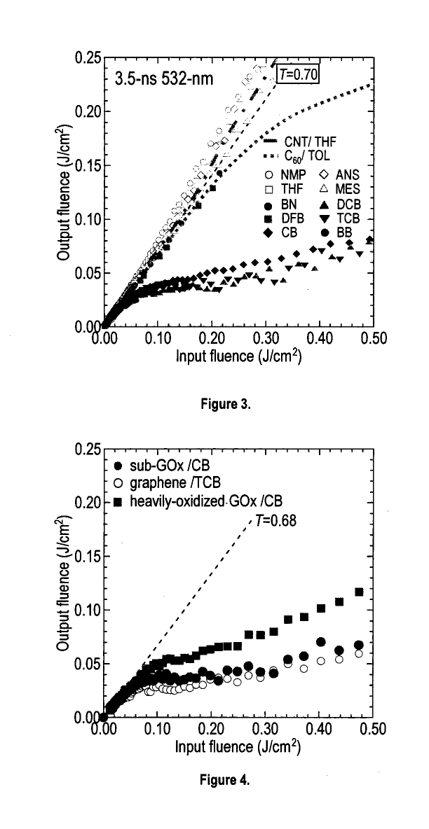

FIG. 3 shows typical result of the output Fₒᵤₜ vs input Fᵢₙ fluence characteristic of the ODA-functionalized sub-GOx in different liquid dispersions measured for 3.5-ns pulses at 532-nm wavelength in air. The Fₒᵤₜ/Fᵢₙ ratio gives the internal sample transmittance T and the limiting slope dFₒᵤₜ/dFᵢₙ gives the limiting differential transmittance T′ at higher fluence. There is remarkable switchover of behavior from saturable absorption to OL for the same functionalized sub-GOx at a linear T=0.70. Saturable absorption (with T′≈0.9 at Fₙ≈500 mJ cm⁻²) evolving slowly to OL at Fᵢₙ>700 mJ cm⁻² was found in N-methylpyrrolidone (NMP), tetrahydrofuran (THF), anisole (ANS) or mesitylene (MES) as the dispersion solvent. This behavior is similar to recent reports of high OL threshold for suspended graphenes and GOx in some of these solvents. However in chlorobenzene (CB), 1,2-dichlorobenzene (DCB) and 1,2,4-trichlorobenzene (TCB), the same sub-GOx exhibits OL beginning at ca. 10 mJ cm⁻² with T′=0.10 at Fᵢₙ=500 mJ cm⁻².

### Exemplification 11

### Optical Limiting Effect of Sub-GOx, GOx and Ultrasonically Exfoliated Graphene in Heavy-Atom Solvents

FIG. 4 shows this giant OL enhancement can also be found in ultrasonically-exfoliated graphene nanosheets. The Fₒᵤₜ vs Fᵢₙ characteristics of the functionalized GOx and sub-GOx with graphene in heavy-atom liquid cells, all at the same T=0.68. It is clear that graphene dispersed in TCB shows a F₅₀ threshold that is a factor of ten lower than previously reported for suspensions in NMP and DMF (also measured here). In fact its behavior is practically identical to that of sub-GOx. This confirms that the NLO response of sub-GOx arises primarily from its extended π-electron system in the graphenite patches, rather than some other structural factors. Although ultrasonically-exfoliated graphene dispersions can also exhibit this enhancement, they exhibit markedly inferior stability and cannot be dispersed into solid film matrices without extensive aggregation. The disordered functionalized sub-GOx thus provides “graphene” properties in a technologically useful solution-processable form, and can also serve as a useful experimental model for the much less tractable unfunctionalized parent.

### Exemplification 12

### Differential Scanning Calorimetry of Functionalized Graphene in Films

Polymer solutions in tetrahydrofuran were prepared from two insulating polymers, poly(methyl methacrylate) (PMMA) (17 mg/mL) and polystyrene (PS) (17 mg/mL), and a semiconducting polymer poly(9,9-octylfluorene-alt-triarylamine) (TFB) 25 mg/mL ODA-functionalized sub-GOx was added to the respective polymer solutions to give ODA-GO-to-polymer weight ratio of ca. 25:1. They were then analysed for phase separation by differential scanning calorimetry (DSC). (see FIG. 5) This shows that the presence of the functionalized sub-GOx nano-sheets at such a low concentration is sufficient to markedly constrain molecular motion of the polymer chain segments and hence raise their T_{g} in these two model amorphous polymers. Such an effect indicates that the additive (in this case functionalized sub-GOx) is homogeneously and well-dispersed among the polymer chains. Therefore, it is possible to conclude that the functionalized sub-GOx nano-sheets did not aggregate during drop casting of the films, but remained dispersed substantially as single sheets.

### Exemplification 13

### Transient Absorption of Sub-GOx in CB that Demonstrates the Mechanism for Optical Limiting is Excited State Absorption

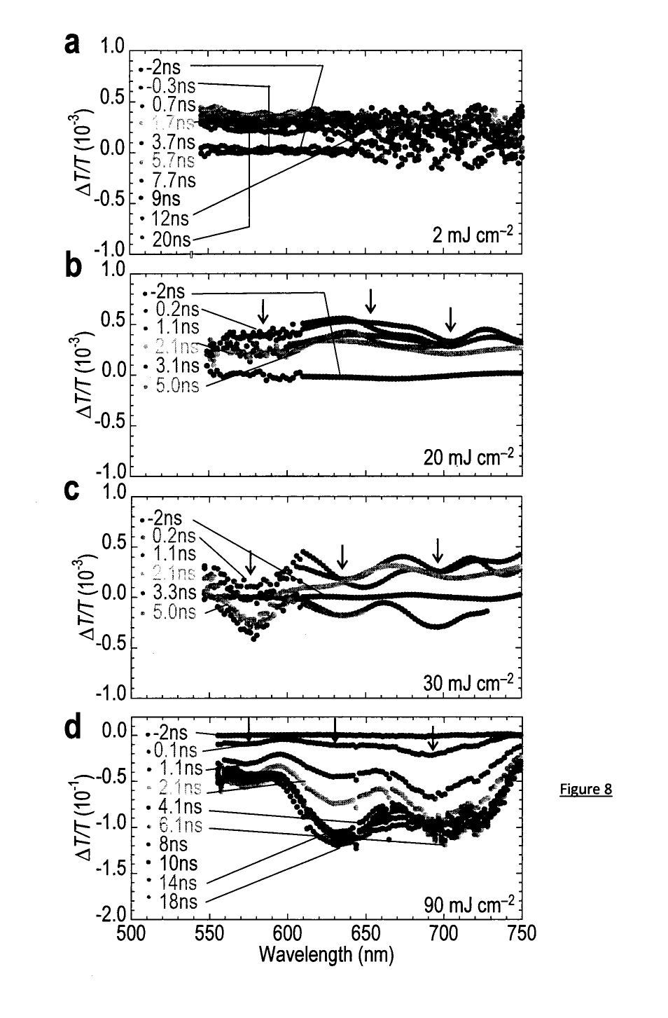

FIGS. 8 (a)-(d) show the ΔT/T spectra of sub-GOx in CB for different probe delays and pump fluences. Zero delay corresponds to coincidence of the centers of the 532-nm pump and broadband probe pulses. For a pump fluence of 2 mJ cm⁻² which is well below the nonlinearity onset, the transient response is a spectrally-flat photo-induced bleaching, i.e., positive ΔT/T. This is characteristic of blocking of the optical joint-density-of-states by the photo-excited electron-hole plasma, which indicates the electrons and holes are substantially delocalized within the nano-graphene domains. There is an unusually long tail with lifetime of ca. 20 ns which suggests trapping. Similar results have been obtained in other solvents including mesitylene and anisole.

At a higher fluence of 20 mJ cm⁻², the photo-bleaching is still present but attenuated by induced absorptions that emerge within the first 0.2 ns (instrument-limited) with dips at 2.1, 1.9 and 1.75 eV. At 30 mJ cm⁻², the photo-absorption dips become more pronounced and dominate the response after ca. 2 ns. At 90 mJ cm⁻², the transient response is firmly photoinduced absorption across the entire spectral window beginning at the sub-ns time scale. There is a roll-off of the absorption beyond 700 nm, as found also in the wavelength-dependent OL data. Absorption bands are again found at 2.15, 1.95 and 1.80 eV. The dynamics is complicated by the presence of slow rise components having rise times of 1-3 ns, and multiple decay lifetimes from 6 to 45 ns.

The fast emergence of transient absorption demonstrates that the leading mechanism for the giant OL effect in liquid cells is excited-state absorption. This absorption is characteristic of localized excited states typically associated with molecular π-electron systems. The average band spacing is 0.15-0.20 eV, which coincides with the Raman modes of graphene (G band, 0.195 eV; and D band, 0.165 eV) and we assign to the vibronic spacing of excitonic states. This interpretation receives support from (i) the heavy-atom effect, (ii) the large apparent optical cross-section of these states which we estimate from the T′/T ratio to be ≈10⁻¹⁷ cm² per basal carbon, and (iii) long excitation life times.

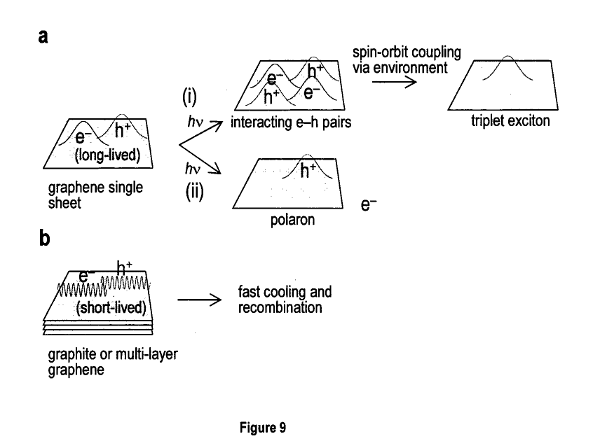

The fluence- and time-dependent crossover from induced transparency to induced absorption is different from the usual behavior of small π-electron systems. These characteristics suggest the excitons here are generated not by direct excitation or the usual singlet→triplet intersystem crossing, but by interactions within the initial electron-hole gas in a nonlinear mechanism. This leads us to speculate that the initial electron-hole gas condenses to triplet-like excitons when promoted by spin-orbit coupling with heavy atoms, as schematically illustrated by path (i) of FIG. 9a. In contrast in graphite or multi-layer graphenes in which the inner layers are effectively isolated from the environment, the electron-hole gas cools and recombines rapidly (FIG. 9b). The mechanism in solid films is even less well understood, but must nevertheless also derive from localization effects. The apparent dependence on the electron-accepting ability of the matrix however hints at a photoinduced charge-transfer mechanism (path (ii) of FIG. 9a). This possibility is suggested by the significant increase in absorption of sub-GOx over when p-doped with a powerful electron-acceptor tetrafluorotetracyanoquinonedimethane (Exemplification 14). The apparent absorption cross section of the doped holes (3×10⁻¹⁷ cm²) is one order of magnitude larger than that contributed by a carbon atom to the ground-state absorption of graphene, and occurs over a wide Vis-NIR region, which explains the excellent output clamping obtained. This large oscillator strength is characteristic of localization and suggests a polaronic character well known in π-conjugated polymers. This mechanism appears to be remarkably efficient in the solid film and shows little roll-off in efficiency even to 1064-nm wavelength.

### Exemplification 14

### Ground-State p-Doping of Dispersed Functionalized Sub-GOx Single Sheets with Tetrafluorotetracyanoquinonedimethane (F₄TCNQ): Formation of Polaronic Charge Carriers

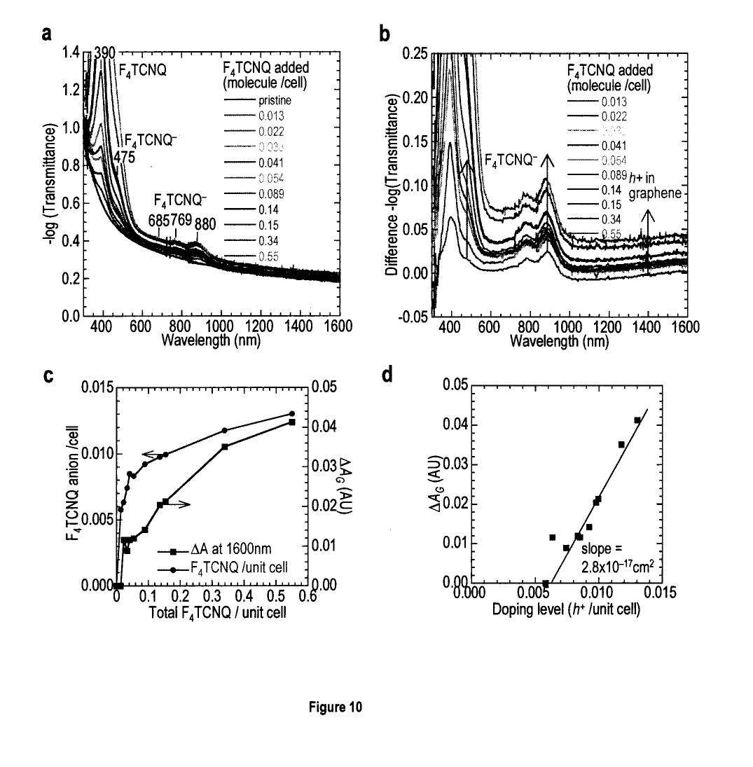

FIG. 10 (a) shows the solution-state UV-Vis-NIR spectra of a dispersion of octadecylamine-functionalized sub-GOx (0.10 mg mL⁻¹) in CB sequentially doped with an increasing ratio of tetrafluorotetracyanoquinonedimethane (F₄TCNQ) at 298 K, measured in a 2.0-mm-path length liquid cell. The tetrafluoro-substituted F₄TCNQ is a more powerful one-electron oxidant than the well known TCNQ, and has been used recently to p-doped π-conjugated polymer semiconductors and epitaxial graphene. The functionalized sub-GOx concentration corresponds to ca. 1.0×10¹⁸ C₂ unit cells/cm² in the basal plane (i.e., counting every two carbon atoms in the basal plane as one cell, but not the alkyl chain). The functionalized sub-GOx sheets remain well-dispersed in the solvent throughout the measurements.

The spectra were collected on a two-beam UV-Vis-NIR spectrophotometer (Shimadzu UV-3600) with a wide dynamic range (up to optical density OD 6). The spectrum of the functionalized sub-GOx dispersion (0.34 mL) was collected, and the progress of oxidation followed by sequentially adding aliquots of F₄TCNQ (Sigma-Aldrich) in CB (1.12 mM) and measuring the spectrum, until the mole ratio of TCNQ to the C₂ units is 0.55. These spectra were then corrected by re-scaling for the dilution effect to display at constant functionalized sub-GOx concentration.

The pristine spectrum of the functionalized sub-GOx shows the usual rising absorption towards shorter wavelengths. The difference spectra obtained by subtraction of the pristine spectrum are shown in FIG. 10 (b). When the first aliquot of F₄TCNQ was added, a new band emerges at 390 nm (3.18 eV) due to the presence of neutral F₄TCNQ molecules (molar absorptivity ε≈25,000 M⁻¹ cm⁻¹) in the mixture. A new set of absorption also emerges at 880 nm (1.41 eV), 769 nm (1.61 eV) and 685 nm (1.81 eV). This is the characteristic electronic spectrum of the F₄TCNQ⁻ anion. The three sub-bands form a vibronic progression, with spacing similar to that of the unsubstituted TCNQ⁻ anion (0.2 eV, ≈1600 cm⁻¹).^{7,8} The ε of the 880 nm sub-band of F₄TCNQ⁻ is estimated to be 16,500 M⁻¹ cm⁻¹ from the known ratio of the corresponding bands in TCNQ.⁸ Similar to TCNQ⁻, there is another band in F₄TCNQ⁻ at 475 nm (2.61 eV) which can be seen as a shoulder on the neutral F₄TCNQ band. Therefore it can be firmly concluded that F₄TCNQ acts as a p-dopant for sub-GOx. It is cleanly reduced to the F₄TCNQ⁻ state, with no dianion state found.

The difference spectra reveal that in addition to these bands, there is an increase of absorption with p-doping over a broad spectral range extending from well below 0.77 eV (i.e., longer than 1600 nm) to at least 2.5 eV (ca. 500 nm), masked at even shorter wavelengths by the intense F₄TCNQ band. The absorbance ΔA_{G} of this doping-induced broadband is clearly a feature of the p-doped nano-graphene domains in the functionalized sub-GOx sheets. Its intensity tracks very well with the ratio of F₄TCNQ⁻ per unit cell, as shown in FIG. 10(c). This ratio also corresponds to the hole per unit cell.

This data is re-plotted in FIG. 10(d) to show ΔA_{G} directly against the doping level given by hole per unit cell. It clearly shows that ΔA_{G} increases linearly with doping-level>6×10⁻³ hole per unit cell. From the linearity we can establish the absorption cross section of the holes in the nano-graphene domains to be 2.8×10⁻¹⁷ cm² using ΔA_{G}=σ b c, where σ is the cross section, b is the pathlength, and c is the number concentration of holes given by the doping level times the number concentration of the unit cells present.

This absorption cross section is one order of magnitude higher than that contributed by a single carbon atom in the ground-state (ca. 2×10⁻¹⁸ cm² per basal carbon atom). This demonstrates that the doping-induced holes in the dispersed functionalized sub-GOx graphene single sheets are significantly localized. If they were delocalized, they would reside at the K point which bleaches out absorption in the far infrared, but should cause no significant change the absorption spectrum in visible-NIR, aside from a tiny effect related to bandgap renormalization.

### Exemplification 15

### Absence of Significant Solvent Perturbation of the Ground-State of the Sub-GOx

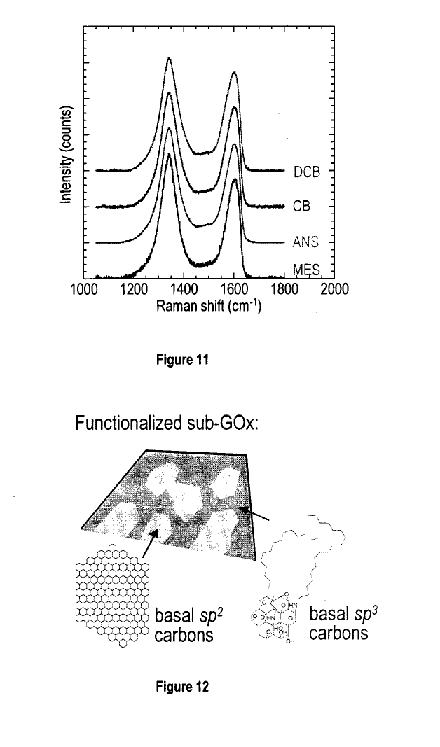

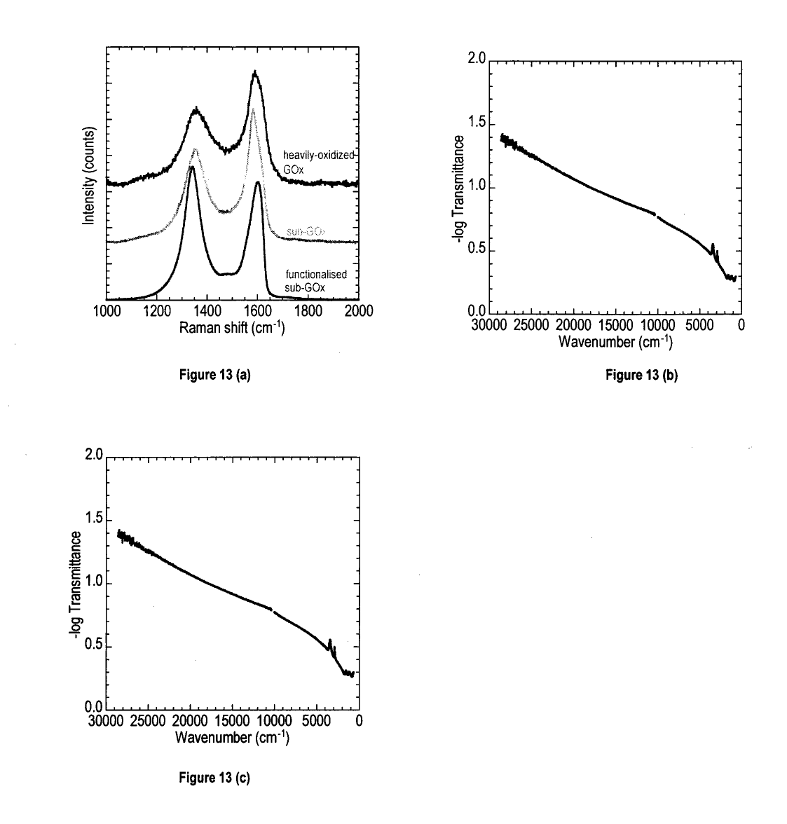

FIG. 11 shows the Raman spectra of the D (1345 cm⁻¹) and G (1600 cm⁻¹) bands in liquid dispersions of the octadecylamine-functionalized sub-GOx in various solvents such as mesitylene (MES), anisole (ANS), chlorobenzene (CB) and 1,2-dichlorobenzene (DCB) at a concentration of ca. 0.1 mg mL⁻¹, similar to that in Z-scan measurements. The spectra are practically identical to the solid film spectrum of the functionalized sub-GOx (FIG. 13). This confirms that no significant ground-state perturbation of the π-electron system of the nano-graphene domains in functionalized sub-GOx as occurred in the solvents. Hence the marked cross-over in NLO characteristics from saturable absorption in MES and ANS to reverse saturable absorption in CB and DCB is not due to a ground-state perturbation by the solvent.

### Exemplification 16

### Chemical Structure of Functionalized Graphene from Sub-Stoichiometric Graphene Oxide

It is important to distinguish between these sub-GOx and the heavily-oxidized GOx which can be obtained by exhaustive oxidation of graphite, although this distinction is often lost in the literature. The fully-oxidized stoichiometric GOx does not have π-electrons, while sub-GOx has a significant fraction of sp²-carbon atoms retained in the basal plane. For sub-GOx that is about one-third- to half-oxidized, the sp²-carbon atoms are organized into nano-graphene domains which are really quite large 2-D π-electron systems in the 10-nm size range (estimated by Raman and infrared spectroscopies in Exemplification 16) separated by boundaries comprising a network of epoxy and/or hydroxyl-bonded sp³-carbon atoms (FIG. 12). These nano-graphene domains can therefore exhibit similar broadband electronic absorption as “perfect” graphene. Furthermore, in contrast to heavily-oxidized GOx, sub-GOx can undergo facile thermal re-graphenization by extending the nano-graphene domains into a “graphenite” network that shows band-like field-effect transport despite disorder. The sp³-carbon atoms in the domain boundaries provide sites for chemical functionalization with a variety of alkyl chains and groups. Therefore these functionalized sub-GOx can be regarded as functionalized graphenes, with the desirable property of being dispersible as single sheets in a variety of solvents and film matrices.

The octadecylamine-functionalized sub-GOx nano-sheets can be repeatedly isolated in the dry state and re-dispersed in a variety of organic solvents (up to 15 mg mL⁻¹) and polymer matrices. The alkyl-chains prevent the re-stacking of these sheets, and therefore promote their dispersability in various matrices.

### Exemplification 17

### Characterization of the Sub-GOx by Raman and Infrared Spectroscopy

FIG. 13 (a) shows the powder Raman spectrum of thin films of a heavily-oxidized GOx, and of sub-GOx before and after chemical functionalization with octadecylamine chains, measured using 514-nm laser excitation through a Raman microscope (Renishaw 2000). The samples were encapsulated in nitrogen using by a thin glass cover slip and parafilm sealant to protect them from possible atmospheric photooxidation during data collection. No change in the spectra occurred between the first and last spectrum collected at the same spot, so no laser-induced damage occurred during data acquisition.

The spectra show the characteristic D band at 1350 cm⁻¹ and G band at 1585 cm⁻¹ with a shoulder at 1620 cm⁻¹. The more heavily-oxidized GOx sample shows greater disorder as expected of its higher oxidation state. Both the shape and position of the D and G bands are remarkably similar to those of nanographites made by high temperature annealing of amorphous carbon thin films. Therefore they result from the same Raman scattering mechanism, with the G band from the graphene, and D band from its perimeter adjacent to the spa defects. Hence we can use the known relationship of the D- to G-band intensity ratio and the size of the perfect graphene domain that has been well-established in nanographites:¹

$${L}_{a} ( nm ) = \frac{560}{{E}_{λ}^{4}} {( \frac{{I}_{D}}{{I}_{G}} )}^{- 1} ,$$

to estimate the average size of the nano-graphene domains in our sub-GOx. Note that this average is closer to the area-weighted average rather than an arithmetic average because the XRD method used to calibrate the size is weighted by the area of the domain. In this way we determined the average domain size to be 6-18 nm. After functionalization, the average domain size becomes smaller, 4-12 nm, but this is still very large compared to the graphene cell length of 0.246 nm.

FIG. 13 (b) shows the UV-Vis-NIR spectrum of our functionalized sub-GOx dispersed in a KBr pellet. This dispersion was performed by grinding the functionalized sub-GOx with KBr powder in a glovebox to protect from moisture adsorption and compacting to a pellet under vacuum and pressure (10 bar). The data was collected separately in the FTIR and UV-Vis spectral regions and stitched together. The scattering losses in the KBr pellet is small (typically <0.1 absorbance units) due to the high clarity achieved in the pellets, and so does not affect the data. The broad absorption band arises from the π-π* electronic transition in the functionalized sub-GOx. The onset of this transition is estimated from the kink in the absorption cross-section to be ca. 0.3 eV.

We can estimate the size of the nano-graphene domain that has an electronic transition at this onset using the known size dependence of the π-π* electronic transition energy of benzenoid polycyclic aromatic hydrocarbons (PAHs).² This approach is valid because very large PAHs (e.g., C₂₂₂) do indeed show an absorption band profile very similar to what is observed here, i.e., an absorption edge followed by a broad featureless plateau that extends to higher energies. To extrapolate the experimental relationship to the size range found in our samples, we were guided by the simple theory that the energy gap between the highest occupied and lowest unoccupied levels of a large 2-D quantum well should scale as 1/L where L is a linear dimension of the well.

In FIG. 13 (c), we thus replotted the data from FIG. 10 of Ref.[2] to show the energy of the π-π* gap (E_{π-π*}) vs the size of the benzenoid PAH (L). L is measured by the square root of the number of aromatic sextets in the PAH. We chose the functional form

$${E}_{π - {π}^{*}} = \frac{A}{( L + B )}$$

to fit the data, and obtained best fit with A=9.13±0.37 and B=0.75±0.13. Thus the π-π* transition onset of ca. 0.30 eV in our functionalized sub-GOx suggests that a population of the nano-graphene domains has a diameter of 30 aromatic sextets or 60 basal C₂ unit cells (in the honeycomb lattice). This corresponds to a diameter of 12 nm, which is in excellent agreement with the estimate obtained from Raman spectroscopy.

Hence we can conclude that nano-graphene domain of 4-12-nm across which corresponds to 20-60 unit cells in diameter are present in our functionalized sub-GOx. The presence of such large graphenites is in fact consistent also with the previous observation of band-like transport in gated conductivity measurements, and with scanning tunneling microscopy of the thermal re-graphenization process.

1. An optical-limiter comprising:
chemically functionalized graphene substantially spaced apart as single sheets in a substantially transparent liquid cell or solid thin film.

2. The optical-limiter in claim 1, where the chemical functionalization comprises both sub-stoichiometric oxidation, and attachment of surface modifier groups, wherein the surface-modifier group comprises solubilizing groups from the class including alkyl, cycloalkyl, aryl, arylalkyl, fluoroalkyl and fluoroaryl groups; and/or ionic groups from the class including carboxylic acid, sulfonic acid, phosphonic acid and their salts, quarternary ammonium; and/or polar groups from the class including ester, amide, nitro, cyano; sulfone, sulfoxide; and/or groups bearing heavy atoms with atomic numbers bigger than 20 including sulfur, chlorine, bromine, iodine, silver, gold platinum, palladium, yttrium, zirconium, lanthanum, cerium, caesium, barium; and/or electron withdrawing groups from the class including tetracyanoquinodimethane; and/or electron donating groups from the class including triarylamine.

3. The optical-limiter in claim 1, wherein the liquid cell is from the class of heavy atom solvents bearing atoms with its atomic number bigger than 20 including sulphur, chlorine, bromine and iodine.

4. The optical-limiter in claim 3, wherein the liquid cell is from the class of haloaromatics including chlorobenzene, dichlorobenzenes, trichlorobenzenes, bromobenzene, dibromobenzenes and tribromobenzenes, and their higher halogenated or mixed halogenated analogues.

5. The optical-limiter in claim 1, wherein the liquid cell includes one or more compounds comprising electron-withdrawing groups such as tetracyanoquinodimethane or electron-donating groups such as triarylamine.

6. The optical-limiter in claim 1, wherein the solid thin film includes a film-forming material from the class of organic polymers such as polycarbonates, polyimides, polyesters, polyacrylates, polycarbazoles, epoxy polymers, novalak, formaldehyde polymers, polyfluorene and polythiophene.

7. The material in claim 6, wherein the polymer or sol-gel materials such as silica titania, silsequioxanes contains one or more groups from the class of heavy-atom, electron withdrawing or electron donating group.

8. The optical-limiter in claim 1, wherein the solid thin film is formed by chemically functionalized graphenes that are spaced apart by more than a few molecular diameter.

9. The optical-limiter in claim 1, where the optical-limiting mechanism occurs by excited state absorption.

10. The optical-limiter in claim 1 wherein the onset of the nonlinear optical limiting effect in the thin film or liquid cell is less than 100 mJ/cm² or more preferably less than 10 mJ/cm² when the linear transmittance preferably fall between 50 and 90%.

11. A device selected from the group consisting of an anti-glare treated device and a sensor protected with pulse shaping, comprising an optical limiter as claimed in claim 1.

12. A method of fabricating an optical response material comprising:
providing chemically functionalized graphene single-sheet dispersion;
and forming a solid thin film or liquid cell including the graphene, wherein the graphene is substantially singularly dispersed within the film or liquid cell.

13. The method in claim 12, wherein forming the film comprises dispersing the chemically functionalized graphene in a solution of a polymer or sol-gel system and depositing the graphene nanocomposite solution on a substrate.

14. The device of claim 11, where the chemical functionalization comprises both sub-stoichiometric oxidation, and attachment of surface modifier groups, wherein the surface-modifier group comprises solubilizing groups from the class including alkyl, cycloalkyl, aryl, arylalkyl, fluoroalkyl and fluoroaryl groups; and/or ionic groups from the class including carboxylic acid, sulfonic acid, phosphonic acid and their salts, quarternary ammonium; and/or polar groups from the class including ester, amide, nitro, cyano; sulfone, sulfoxide; and/or groups bearing heavy atoms with atomic numbers bigger than 20 including sulfur, chlorine, bromine, iodine, silver, gold platinum, palladium, yttrium, zirconium, lanthanum, cerium, caesium, barium; and/or electron withdrawing groups from the class including tetracyanoquinodimethane; and/or electron donating groups from the class including triarylamine.

15. The device of claim 11, wherein the liquid cell is from the class of heavy atom solvents bearing atoms with its atomic number bigger than 20 including sulphur, chlorine, bromine and iodine.

16. The device of claim 15, wherein the liquid cell is from the class of haloaromatics including chlorobenzene, dichlorobenzenes, trichlorobenzenes, bromobenzene, dibromobenzenes and tribromobenzenes, and their higher halogenated or mixed halogenated analogues.

17. The device of claim 11, wherein the liquid cell includes one or more compounds comprising electron-withdrawing groups such as tetracyanoquinodimethane or electron-donating groups such as triarylamine.

18. The device of claim 11, wherein the solid thin film includes a film-forming material from the class of organic polymers such as polycarbonates, polyimides, polyesters, polyacrylates, polycarbazoles, epoxy polymers, novalak, formaldehyde polymers, polyfluorene and polythiophene.

19. The device of claim 18, wherein the polymer or sol-gel materials such as silica titania, silsequioxanes contains one or more groups from the class of heavy-atom, electron withdrawing or electron donating group.

20. The device of claim 11, wherein the solid thin film is formed by chemically functionalized graphenes that are spaced apart by more than a few molecular diameter.
